(19) United States
(12) Patent Application Publication
(10) Pub. No.: US 2005/0005492 A1
(43) Pub. Date: Jan. 13, 2005

(54) DECORATIVE ARTICLE FOR BAKED GOODS AND METHOD OF APPLYING SAID ARTICLE

(76) Inventor: Carol Elise Pawlak, Castaic, CA (US)

Correspondence Address: LAW OFFICE OF MICHAEL P. EDDY, #510, 2683 VIA DE LA VALLE, SUITE G, DEL MAR, CA, 92014, US

(21) Appl. No.: 10/710,434

(22) Filed: Jul. 10, 2004

Related U.S. Application Data
(60) Provisional application No. 60/485,709, filed on Jul. 10, 2003.

(51) Int. Cl. G09F 23/00

(52) U.S. Cl. 40/637

(57) ABSTRACT

One embodiment of the claimed subject matter is directed to a decorative holder article for a baked good comprising one or more sheets of decorative material formed around said baked good, a ribbon affixed to said one or more sheets, and a decorative accessory affixed to said ribbon. Another embodiment is directed to a decorative holder including a soufflécup for holding said baked good affixed to the one or more sheets. Another embodiment is directed to a decorative holder including one ore more decorative accessories accommodated in the one or more ribbons. Another embodiment includes is a decorative accessory selected from the following group: trinkets, gifts, soaps, bath salts, jewelry, chocolates, nuts, and mints. Another embodiment includes one or more gift items accommodated in the one or more ribbons.

### CROSS REFERENCE TO RELATED APPLICATIONS

This application claims the benefit of U.S. Provisional Application Ser. No. 60/485,709 Filed Jul. 10, 2003 which is incorporated herein by reference in its entirety.

### BACKGROUND OF INVENTION

The present invention relates generally to cake containers, and more specifically, to a method and article for displaying baked goods in decorative containers. Cup shaped containers made out of paper and the like are known for holding various types of baked goods such as cakes and muffins both before and after those goods are being baked. For example, most cupcake liners used in baking are constructed from parchment paper. This parchment paper allows the baked item to be easily removed from the baking liner after it has been filled with cake or muffin batter and baked in an oven. As the batter cooks and solidifies, the parchment paper becomes dull and cloudy in appearance which is not useful for decorative purposes.

Other types of backing cups have also been used with various colors, themes and prints. These cake liners are generally more expensive than standard non decorated parchment type liners. When this type of liner is baked, the decorative attribute frequently is very hard to discern and the liner falls away from the baked good after the baking process is complete. The result is frequently a dry and stale tasting baked product.

### SUMMARY OF INVENTION

The present method and apparatus are directed to a decorative holder article for baked goods. One embodiment of the claimed subject matter is directed to a decorative holder article for a baked good comprising one or more sheets of decorative material formed around said baked good, a ribbon affixed to said one or more sheets, and a decorative accessory affixed to said ribbon. Another embodiment is directed to a decorative holder including a soufflé cup for holding said baked good affixed to the one or more sheets. Another embodiment is directed to a decorative holder including one ore more decorative accessories accommodated in the one or more ribbons. Another embodiment includes is a decorative accessory selected from the following group: trinkets, gifts, soaps, bath salts, jewelry, chocolates, nuts, and mints. Another embodiment includes one or more gift items accommodated in the one or more ribbons.

### BRIEF DESCRIPTION OF DRAWINGS

The claimed subject matter may be embodied in the forms illustrated in the accompanying drawings, attention being called to the fact, however, that the drawings are illustrative only, and that changes may be made in the specific construction illustrated and described within the scope of the appended claims.

FIG. 1 is a top view of a decorative holder article embodiment of the claimed subject matter with a soufflécup.

FIG. 2 is a front perspective view of a decorative holder article embodiment of the claimed subject matter with a soufflécup.

FIG. 3 is an elevated front perspective view of a decorative holder article embodiment of the claimed subject matter with a soufflécup.

### DETAILED DESCRIPTION

In general, the present method and article will allow the colors, themes, and patterns to remain clear, distinct and colorful giving uniformity to a group of party decorations. Embodiments of the claimed subject matter can hold the cupcake liner in place to guarantee the freshness and taste of the cake held within the liner.

The decorative holder article can be an added feature to any previously made cake or baked product. The shape and size of the article can be varied to accommodate most baked goods available, for example smaller in size to accomodate mini-cupcakes or mini-muffins and their related liners or larger in size to accommodate jumbo muffins or larger cakes and any liners. Embodiments of the holder article can be used as a party favor alone or it can be used to accommodate a small gift such as a small gift tied with one or more ribbons onto the article. The embodiments may also be used without baked goods to hold other edible or non-edible items such as trinkets, gifts, soaps, bath salts, jewelry, chocolates, nuts, mints or any similar items.

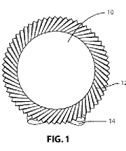

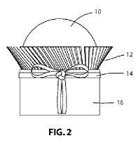

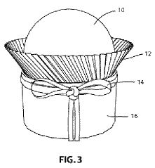

Referring to FIGS. 1 through 3, an embodiment of the decorative baked good holder article is shown with one or more sheets 12 and 16, a ribbon 14 and a cake 10. Sheet 12 and 16 can be a single sheet of material. A gift or similar item (not shown) may also be disposed on or within said ribbon 14.

In one embodiment, the holder has one or more pieces of paper or fabric material, or combination of materials, cut to a circle that is four inches in diameter forming a single sheet made up of sheet 16. Sheet 16 can be made of more than one material. This material can be made of tissue paper, a napkin-like paper, or any other suitable material. A two inch soufflécup 12 is affixed to sheet 16 with glue or a similar substance, and the sheet 16 can cover some or all of the exterior of cup 12. Cake 10 is shown placed inside cup 12 and cake 10 can be any type of cake, muffin or baked good. One or more of ribbon 14 may be placed as an annulet around the sheet 16 or around cup 12 or around both cup 12 and sheet 16. Ribbon 14 can be any ribbon such as 3 mm section of satin ribbon cut to three and one half inches long so that it ribbon 14 can be wrapped radially around cup 12 or sheet 16 or both. Also shown is ribbon 14 formed into a bow which can be glued to the remainder of ribbon 14. Embodiments of the decorative baked good holder article can also be reused and redecorated for other occasions or uses.

While the present invention has been illustrated and described by means of specific embodiments and alternatives, it is to be understood that numerous changes and modifications can be made without departing from the spirit and scope of the invention. Therefore, it should be understood that the invention is not to be limited in any way except in accordance with the appended claims and their equivalents.

1. A decorative holder article for a baked good comprising:
one or more sheets of decorative material formed around said baked good;
a ribbon affixed to said one or more sheets; and
a decorative accessory affixed to said ribbon.

2. A decorative holder of claim 1, further comprising a soufflécup for holding said baked good affixed to said one or more sheets.

3. A decorative holder of claim 1, wherein one or more decorative accessories are accommodated in one or more of said ribbons.

4. A decorative holder of claim 1, wherein said decorative accessory is selected from the following group: trinkets, gifts, soaps, bath salts, jewelry, chocolates, nuts, and mints.

5. A decorative holder of claim 1, wherein one or more gift items are accommodated in one or more of said ribbons.
